(19) United States
(12) Patent Application Publication
(10) Pub. No.: US 2008/0057925 A1
(43) Pub. Date: Mar. 6, 2008

(54) SPEECH-TO-TEXT (STT) AND TEXT-TO-SPEECH (TTS) IN IMS APPLICATIONS

(75) Inventor: Mohammed T. Ansari, Morrisville, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (SE)

(21) Appl. No.: 11/468,334

(22) Filed: Aug. 30, 2006

(51) Int. Cl. H04L 29/08

(52) U.S. Cl. 455/414.4

(57) ABSTRACT

A device and method of presenting the payload of data received in an IP Multimedia Subsystem (IMS) supported format based on the current status of a portable mobile communications device is disclosed. The portable mobile communications device receives data in an IP Multimedia Subsystem (IMS) supported format. The portable mobile communications device then determines its current status to determine whether incoming IMS data should be presented as text or as speech. Next, it is determined whether the payload of the received data is in textual or audible form. The data payload is converted from text to speech or from speech to text if the original data payload format is incompatible with the data output options associated with the current status of the portable mobile communications device.

### BACKGROUND OF THE INVENTION

Portable mobile communications devices such as mobile phones are becoming more sophisticated and include many new features and capabilities. The wireless telecommunications industry is currently in the midst of migrating toward a convergence of networks. This convergence is largely due to the continuing development of the IP Multimedia Subsystem (IMS).

IMS can be characterized as a new core and service domain that enables the convergence of data, speech and network technology over an IP-based infrastructure. For users, IS-based services will enable communications in a variety of modes including voice, text, pictures and video, or any combination of these in a highly personalized and secure way.

The IP Multimedia Subsystem (IMS) is a standardized architecture for telecom operators that want to provide mobile and fixed multimedia services. It uses a Voice-over-IP (VoIP) implementation based on an implementation of the Session Initiation Protocol (SIP), and runs over the standard Internet Protocol (IP). Both packet-switched and circuit-switched phone systems are supported. IMS is designed to fill the gap between the existing traditional telecommunications technology and internet technology that increased bandwidth alone does not provide.

SIP is a protocol for initiating, modifying, and terminating an interactive user session that involves multimedia elements such as video, voice, instant messaging, online games, and virtual reality. When SIP/IMS based incoming data messages arrive in the portable mobile communications device and the IMS application is running in background, it is possible for the user to hear or see the message while interacting with a different application on the portable mobile communications device.

What is needed is a system and/or method of determining whether the incoming SIP/IMS based data should be converted to a different format (speech-to-text or text-to-speech) so as not to interrupt an ongoing application.

### BRIEF SUMMARY OF THE INVENTION

In one embodiment, a method of presenting the payload of data received in an IP Multimedia Subsystem (IMS) supported format based on the current status of a portable mobile communications device is disclosed. The portable mobile communications device receives data in an IP Multimedia Subsystem (IMS) supported format. The portable mobile communications device then determines its current status to determine whether incoming IMS data should be presented as text or as speech. Next, it is determined whether the payload of the received data is in textual or audible form. The data payload is converted from text to speech or from speech to text if the original data payload format is incompatible with the data output options associated with the current status of the portable mobile communications device.

In another embodiment, a portable mobile communications device that presents the payload of data received in an IP Multimedia Subsystem (IMS) supported format based on the current status of the portable mobile communications device is disclosed. The portable mobile communications device includes RF circuitry for receiving data in an IMS supported format. An IMS application determines the current status of the portable mobile communications device that specifies the current data output format to be used for incoming IMS payload data. A speech to text conversion application for converting voice data to text data and a text to speech conversion application for converting text data to voice data are included to perform payload data conversions if necessary. A processor interfaces with the RF circuitry, the IMS application, the speech to text conversion application, the text to speech conversion application, a display, and an audio output mechanism to process the IMS data received by the RF circuitry and cause the received IMS payload data to be presented in a text format via the display if the current status of the portable mobile communications device specifies text output and presented audibly via the audio output mechanism if the current status of the portable mobile communications device specifies audible output.

### BRIEF DESCRIPTION OF THE DRAWINGS

FIG. 1 is a block diagram of the internal hardware and software components within a portable mobile communications device that comprise the present invention.

FIG. 2 is a flowchart illustrating the processes and data flow caused by execution of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

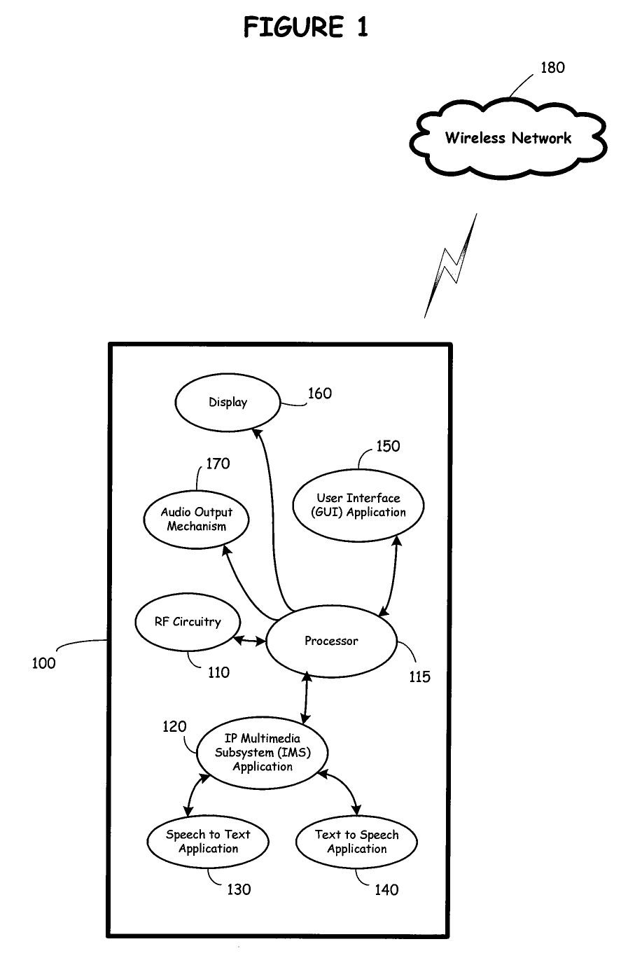

FIG. 1 is a block diagram of the internal hardware and software components within a portable mobile communications device 100 that work together to achieve the goals of the present invention. The portable mobile communications device 100 naturally includes RF circuitry 110 for sending and receiving wireless voice/data transmissions over a wireless network 180. The RF circuitry is broadly illustrated for simplicity to indicate the reception and transmission of all wireless exchanges. It maybe that there are more than one RF circuits or applications that are directed to different types of RF transmissions that utilize different RF protocols or standards. It is common for a portable mobile communications device to be fluent in many RF protocols for voice and for data. For instance, the portable mobile communications device can handle voice traffic according to a GSM standard while data can be sent or received using any number of protocols including, but not limited to, GPRS, EDGE, UMTS, or HSPDA. For purposes of the present invention, RF protocols that are Internet Protocol (IP) based and can be managed by an IP Multimedia Subsystem (IMS) application apply. Moreover, data can include voice data in a packetized Voice over IP (VoIP) format.

The RF circuitry 110 is coupled with a processor 115. The portable mobile communications device 100 processor 115 also executes instructions associated with an IP Multimedia Subsystem (IMS) application 120. The IMS application 120 contains the intelligence necessary for handling incoming and outgoing IMS data exchanges with the wireless network 180. The IMS application further manages a speech to text conversion application 130 as well as a text to speech conversion application 140 via the processor 115. The user interfaces with the IMS application 120 using a graphical user interface (GUI) application 150 controlled by the processor 115. A display 160 and an audio output mechanism 170 are included to provide visual and audible output to the user. The audio output mechanism 170 can be a speaker or an interface to a headset accessory.

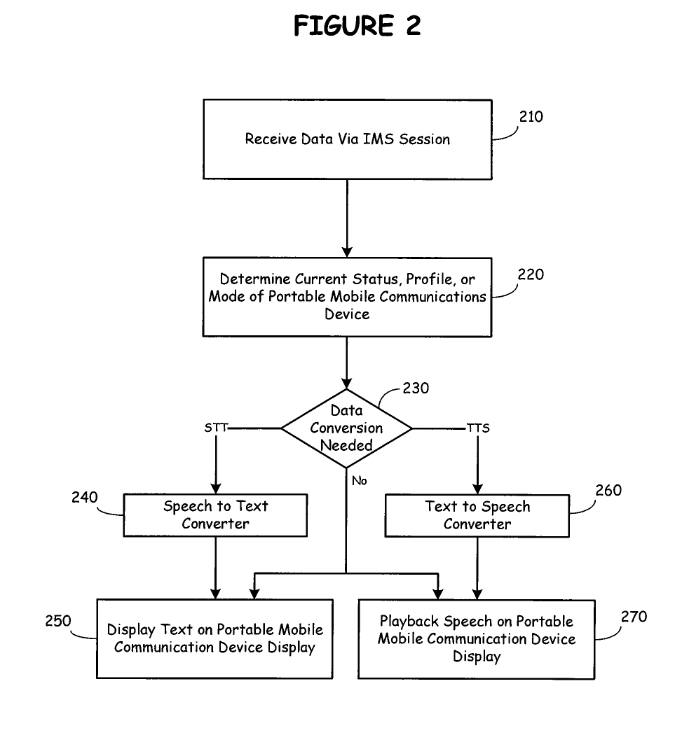

FIG. 2 is a flowchart illustrating the processes and data flow caused by execution of the present invention. The process is initiated when the portable mobile communications device receives data from the wireless network in a compatible IMS format 210. At the time of receiving the IMS data, the portable mobile communications device will be operating in a particular mode, or according to a desired profile, or generally possess a current status. An example of a mode would be silent. Silent mode means that no audible indicators or alerts are permitted. This mode is usually chosen when the user does not wish to disturb the environment with unwanted sounds. Another mode might be non-visual. A non-visual mode may involve having the portable mobile communications device present all output to the user in audible format. This can be extremely helpful to users that are vision impaired, for instance. Thus, received messages with a text payload (e.g., SMS) can be tagged for text to speech conversion. An example of a configurable profile could be ‘meeting’. A meeting profile could be one in which the user specifies silent mode and has all incoming calls directly diverted to a voice mailbox. Incoming data messages can be automatically displayed in full or just show the header information. Alerts can be set to vibrate so as not to elicit any sound. If an incoming data message contains a payload of voice data it can be tagged for speech to text conversion to avoid making noise while retrieving the message. In addition, the user may be operating another application on the portable mobile communications device when the message arrives. The other application may already be using the display (e.g., photo viewer) or audio output mechanism (e.g., MP3 player) meaning that the received message would have to use an alternative output means.

Upon reception of an IMS data message, the IMS application will determine the status, profile, or mode of operation currently associated with the portable mobile communications device 220. This is done to determine how to present the received payload data to the user based on the current settings of the portable mobile communications device. The IMS application also determines the format of the payload of the received data. The payload may be text data, voice data, or image data. The IMS application then correlates the payload data format with the current settings of the portable mobile communications device that define the output format(s) currently available for use to determine if a data conversion (e.g., speech-to-text or text-to-speech) is required 230. For instance, if the portable mobile communications device is in silent mode and the incoming message contains voice data in the payload, then a data conversion would be needed to present the payload to the user given the current settings of the portable mobile communications device. If a speech to text conversion is needed then a speech to text converter is applied to the payload 240 and the resulting text is displayed on the portable mobile communications device display 250. If a text to speech conversion is needed then a text to speech converter is applied to the payload 260 and the resulting audio is played on the portable mobile communications device audio output mechanism 270.

Consider the following examples that illustrate how the present invention functions. In a first example, the user is in a meeting that cannot be interrupted by extraneous or spontaneous alerts or conversations. Therefore, the user sets his portable mobile communications device to the meeting profile which places the portable mobile communications device in silent mode. During the meeting the user receives a push-to-talk over cellular (PoC) burst from another user. Since the PoC burst is in IP format it can be handled by the IMS application. However, the meeting profile prevents the PoC burst from being audibly played. The IMS application determines the current mode of the portable mobile communications device and converts the PoC burst to text so that it can be displayed to the user rather than audibly output.

In another example, a visually impaired user receives an IP based text message. The user has set his portable mobile communications device profile to play audio whenever possible. The IMS application determines that the text payload should be converted to speech for this user. The conversion is made and the portable mobile communications device audibly outputs the message.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

In general, the routines executed to implement the embodiments of the invention, whether implemented as part of an operating system or a specific application, component, program, object, module or sequence of instructions will be referred to herein as “computer programs”, or simply “programs”. The computer programs typically comprise one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media, such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. In a portable mobile communications device, a method of presenting the payload of data received in an IP Multimedia Subsystem (IMS) supported format based on the current status of the portable mobile communications device, the method comprising:
receiving data in an IP Multimedia Subsystem (IMS) supported format;
determining the current status of the portable mobile communications device to determine whether incoming IMS data should be presented as text or as speech;
determining whether the payload of the received data is in textual or audible form; and
converting the data payload from text to speech or from speech to text if the original data payload format is incompatible with the data output options associated with the current status of the portable mobile communications device.

2. A portable mobile communications device that presents the payload of data received in an IP Multimedia Subsystem (IMS) supported format based on the current status of the portable mobile communications device comprising:
RF circuitry for receiving data in an IMS supported format;
an IMS application for determining the current status of the portable mobile communications device that specifies the current data output format to be used for incoming IMS payload data;
a speech to text conversion application for converting voice data to text data;
a text to speech conversion application for converting text data to voice data; and
a processor interfaced with the RF circuitry, the IMS application, the speech to text conversion application, the text to speech conversion application, a display, and an audio output mechanism for processing the IMS data received by the RF circuitry and causing the received IMS payload data to be presented in a text format via the display if the current status of the portable mobile communications device specifies text output and presented audibly via the audio output mechanism if the current status of the portable mobile communications device specifies audible output.

3. In a portable mobile communications device, a computer program product embodied on a computer readable medium for presenting the payload of data received in an IP Multimedia Subsystem (IMS) supported format based on the current status of the portable mobile communications device, the computer program product comprising:
computer program code for receiving data in an IP Multimedia Subsystem (IMS) supported format;
computer program code for determining the current status of the portable mobile communications device to determine whether incoming IMS data should be presented as text or as speech;
computer program code for determining whether the payload of the received data is in textual or audible form; and
computer program code for converting the data payload from text to speech or from speech to text if the original data payload format is incompatible with the data output options associated with the current status of the portable mobile communications device.
